(19) United States
(12) Patent Application Publication
(10) Pub. No.: US 2010/0125525 A1
(43) Pub. Date: May 20, 2010

(54) PRICE ALTERATION THROUGH BUYER AFFECTED AGGREGATION OF PURCHASERS

(76) Inventor: Anil B. Inamdar, Dublin, CA (US)

Correspondence Address: Raj Abhyanker LLP, 1580 West, El Camino Real, Suite 8, Mountain View, CA, 94040, US

(21) Appl. No.: 12/272,816

(22) Filed: Nov. 18, 2008

(51) Int. Cl. G06Q 30/00; G06Q 10/00

(52) U.S. Cl. 705/80; 705/400; 705/26

(57) ABSTRACT

A method, apparatus, and system of price alteration through buyer affected aggregation of purchasers are disclosed. In one embodiment, a method of buyer altered aggregation of purchasers includes generating an offer of at least two of an item (e.g., a good, a real property, an intangible property, and/or a service) for sale at a conditionally determined price to a potential buyer, acquiring an additional potential buyer. The method includes aggregating a set of potential buyers to affect the conditionally determined price. In addition, the method includes selling at least two of the item at the conditionally determined price to the set of potential buyers at a predetermined time.

### FIELD OF TECHNOLOGY

This disclosure relates generally to a system, an enterprise method, a technical field of software and/or hardware technology and, in one example embodiment, to a price alteration through buyer affected aggregation of purchasers.

### BACKGROUND

A computer-based method of selling an item (e.g., a good and/or service) may increase a price based on a competing offer by a potential buyer. The method may be unable to reduce an offer price to a potential buyer, which may force the potential buyer to seek another source to purchase the item.

The method may be unable to alter a quantity of the item (e.g., a quantity of a good and/or service, a duration of a service, etc.) based on a quantity of a desired item and/or a size of a set of potential buyers. As a result, a seller may be unable to sell the item to the potential buyer.

The method may be unable to encourage the potential buyer to identify and/or communicate with an additional potential buyer to increase the quantity of the item that may be sold. In addition, the method may include a price inflexibility and/or an inability to encourage an increased volume of a sale, which may lead to a lower profit and/or a failure to compete with another seller of the item. The loss of the potential buyer and/or the reduction in the total number of units sold may lead to a failure of a business.

### SUMMARY

A method, apparatus, and system of price alteration through buyer affected aggregation of purchasers are disclosed. In one aspect, a method of a buyer altered aggregation of purchasers includes generating an offer of at least two items (e.g., a good, a real property, an intangible property, and/or a service) for sale at a conditionally determined price to a potential buyer, and acquiring an additional potential buyer. The method includes aggregating a set of potential buyers to affect the conditionally determined price. A processor and a nonvolatile memory may be used to aggregate the set of potential buyers. The set of potential buyers may include the potential buyer and/or the additional potential buyer, who may be identified and/or contacted by the potential buyer. In addition, the method includes selling at least two of the items at the conditionally determined price to the set of potential buyers at a predetermined time.

The conditionally determined price may be a predetermined set of two or more tiers (e.g., each tier may include a range of a quantity of the item purchased). Each tier may be associated with a price of the item (e.g., a good, a real property, a service, etc.). The price of the item in the tier may be less than the price of the item in an additional tier. An upper threshold quantity (e.g., a maximum quantity of items in a tier) of a purchased item of the tier may be greater than an additional upper threshold quantity of the additional tier.

Aggregating the set of potential buyers may increase a number of committed purchases of the item, which may reduce the purchase price of the item. The purchase price of the item may be reduced by the number of confirmed purchases in accordance with the conditionally determined price. Aggregating the set of potential buyers may commit each buyer to purchase one or more of an item at the conditionally determined price (e.g., a price determined by a quantity of items sold in accordance with a set of price tiers). The conditionally determined price (e.g., a fixed cash value, a cash value determined by an equation, a cash value determined with each buyer added to the set of potential buyers, etc.) may be reduced by a preselected amount with each buyer added to the set of potential buyers. The preselected amount may be the same for each reduction of the conditionally determined price.

The conditionally determined price may be selected (e.g., chosen by a potential buyer and/or seller). The conditionally determined price may be associated with a threshold quantity (e.g., a minimum number) of the purchased item. The sale of the item to the aggregated set of potential buyers may occur when the threshold quantity of the purchased item is exceeded. The aggregated set of potential buyers may not be committed to purchase the item until the threshold quantity of the purchased item is exceeded. The offer may be communicated to the other potential buyer using an email, a fax, a text message, an instant message, a phone call, a voice message, an image, and/or a photo. The buyer altered aggregation of purchasers method may include storing a data including a transaction record and/or a potential buyer information.

The method may also include identifying a supplemental potential buyer (e.g., a third party, a previously unidentified potential buyer) based on a purchase history and/or a potential buyer characteristic (e.g., an age, a gender, an employment category, a demographic, etc.) that may be associated with the potential buyer, the additional potential buyer, and/or the supplemental potential buyer. The purchase history and/or buyer characteristic may be related to the potential buyer, the additional potential buyer, and/or the supplemental potential buyer. The method may suggest that the potential buyer contact the supplemental potential buyer (e.g., a third party) based on that person's purchase history. The supplemental potential buyer may be known to the potential buyer and/or included in a list of contacts of the potential buyer. A machine may be caused to perform the identification by a processor executing a set of instructions stored in a machine readable medium of a physical memory.

In another aspect, the buyer altered aggregation of purchasers system includes an offer module to generate an offer of at least two items (e.g., a good, a real property, an intangible property, etc.) for sale at a conditionally determined price (e.g., a preset price, a price associated with a range of committed buyers, etc.) to a potential buyer. The system includes an acquisition module to acquire (e.g., identify as a potential buyer, contact via email, communicate with to enable an offer, etc.) an additional potential buyer. The additional potential buyer may be contacted by the potential buyer, and/or the system may include a communication module to enable communication between the potential buyer and the additional potential buyer.

The system also includes an aggregation module to aggregate a set of potential buyers (e.g., the set of potential buyers may include the potential buyer and/or the additional potential buyer) to affect the conditionally determined price. The processor and a nonvolatile memory may be used to aggregate the set of potential buyers. In addition, the system includes a sale module to sell at least two of the items at the conditionally determined price to the set of potential buyers at a predetermined time. Aggregating a set of potential buyers may group together buyers who have provided information to allow the sale to occur at a predetermined time. Aggregating a set of potential buyers (e.g., collecting a set of buyers to purchase one or more items) may commit each buyer to purchase one item at the conditionally determined price.

The item may be a good, a real property, an intangible property, and/or a service. The conditionally determined price may be a predetermined set of two or more tiers. Each tier (e.g., associated with a price of the item) may include a range of an amount of the item purchased. The range may include only a single item, or the range may vary between one item and any number of items greater than one. The price of the item of the tier may be less than the price of the item in an additional tier. An upper threshold quantity of a purchased item of the tier may be greater than an additional upper threshold quantity of the additional tier. The price of the item of a tier with more purchased items may be lower than a price associated with a tier with fewer purchased items. Aggregating a set of potential buyers may commit each buyer to purchase (e.g., buy) one item at the conditionally determined price.

In yet another aspect, the method includes forming an offer module of a buyer aggregation system to offer two or more of an item (e.g., a good, a real property, an intangible property, and/or a service) for sale at a conditionally determined price to a potential buyer, creating an acquisition module to acquire (e.g., identify as a potential buyer, contact via email, communicate with to enable an offer, etc.) an additional potential buyer. The method also includes creating an aggregation module to aggregate a set of potential buyers to affect the conditionally determined price (e.g., the set of potential buyers may include the potential buyer and the additional potential buyer). Aggregating the set of potential buyers may increase a number of committed purchases of the item, which may reduce the purchase price of the item. The purchase price of the item may be reduced by the number of confirmed purchases in accordance with the conditionally determined price. The processor and a nonvolatile memory may be used to aggregate the set of potential buyers. In addition, the method includes forming a sale module to sell at least two of the items at the conditionally determined price to the set of potential buyers at a predetermined time.

The methods, systems, and apparatuses disclosed herein may be implemented by any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view illustrating the buyer aggregation system, according to one embodiment.

FIG. 2A and FIG. 2B are schematic views illustrating migration from one price tier to another price tier, according to one embodiment.

FIG. 3 is a user interface view illustrating buyer interface 320, according to one embodiment.

FIG. 4 is a user interface view illustrating seller interface 460, according to one embodiment.

FIG. 5 is a category management interface 500 view, according to one embodiment.

FIG. 6 is a product management interface 600 view, according to one embodiment.

FIG. 7 is a table view illustrating a user database 700, according to one embodiment.

FIG. 8 is a system view of a data processing system in which any of the embodiments disclosed herein may be performed, according to one embodiment.

FIG. 9 is a process flow illustrating aggregating a set of potential buyers to affect a conditionally determined price, according to one embodiment.

FIG. 10 is a process flow illustrating generation of modules in a buyer aggregation system for selling items, according to one embodiment.

FIG. 11 is a system view illustrating a potential buyer communicating with a network and modules of the buyer aggregation system, according to one embodiment.

Other features of the present embodiments will be apparent from the accompanying drawings and from the detailed description that follows.

### DETAILED DESCRIPTION

A method, apparatus, and system of price alteration through buyer affected aggregation of purchasers are disclosed. Although the present embodiments have been described with reference to specific example embodiments, it will be evident that various modifications and changes may be made to these embodiments without departing from the broader spirit and scope of the various embodiments.

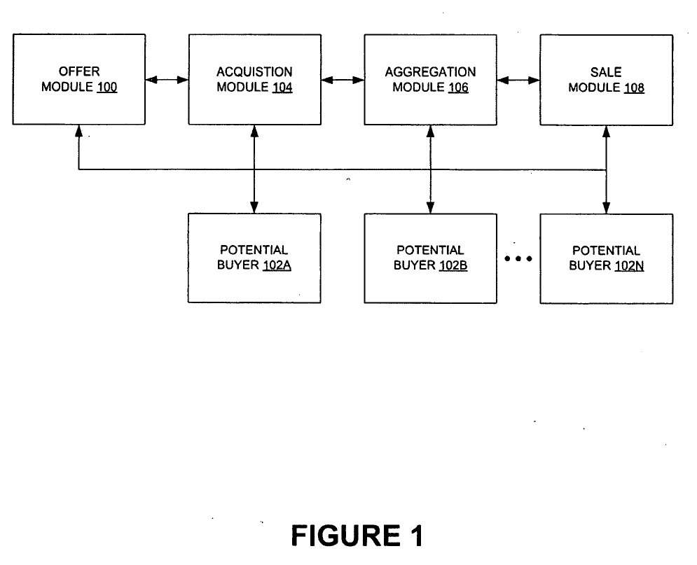

In one embodiment, a method of buyer altered aggregation of purchasers includes generating an offer of at least two items (e.g., a good, a real property, an intangible property, and/or a service) for sale at a conditionally determined price to a potential buyer (e.g., the potential buyer-102A-N of FIG. 1), and acquiring an additional potential buyer. The method includes aggregating (e.g., associating with a price tier, incorporating in a conditionally determined price equation, comparing with a number of confirmed purchases price determination table) a set of potential buyers to affect the conditionally determined price. In addition, the method includes selling two or more of the item at the conditionally determined price to the set of potential buyers at a predetermined time.

In another embodiment, the buyer altered aggregation of purchasers system includes an offer module (e.g., the offer module 100 of FIG. 1) to generate an offer of at least two of an item (e.g., a good, a real property, an intangible property, etc.) for sale at a conditionally determined price to a potential buyer (e.g., the potential buyer-102A-N of FIG. 1). The system includes an acquisition module (e.g., the acquisition module 104 of FIG. 1) to acquire (e.g., identify as a potential buyer, contact via email, communicate with to enable an offer, etc.) an additional potential buyer. The system also includes an aggregation module (e.g., the aggregation module 106 of FIG. 1) to aggregate a set of potential buyers (e.g., the set of potential buyers may include the potential buyer and the additional potential buyer) to affect the conditionally determined price. In addition, the system includes a sale module (e.g., the sale module 108 of FIG. 1) to sell the two or more of the item at the conditionally determined price to the set of potential buyers at a predetermined time.

In yet another embodiment, the method includes forming an offer module (e.g., the offer module 100 of FIG. 1) of a buyer aggregation system to offer two or more of an item (e.g., a good, a real property, an intangible property, and/or a service) for sale at a conditionally determined price to a potential buyer (e.g., the potential buyer-102A-N of FIG. 1), creating an acquisition module (e.g., the acquisition module 104 of FIG. 1) to acquire (e.g., identify as a potential buyer, contact via email, communicate with to enable an offer, etc.) an additional potential buyer. The method also includes creating an aggregation module (e.g., the aggregation module 106 of FIG. 1) to aggregate a set of potential buyers (e.g., the set of potential buyers may include the potential buyer-102A-N and the additional potential buyer) to affect the conditionally determined price (e.g., the set of potential buyers may include the potential buyer and/or the additional potential buyer). In addition, the method includes forming a sale module (e.g., the sale module 108 of FIG. 1) to sell the two or more of the item at the conditionally determined price to the set of potential buyers at a predetermined time.

FIG. 1 is system view illustrating the buyer aggregation system, according to one embodiment. In particular, FIG. 1 illustrates an offer module 100, potential buyer-102A-N, an acquisition module 104, an aggregation module 106, and a sale module 108, according to one embodiment.

The offer module 100 may offer two or more items (e.g., a good, a real property, an intangible property, and/or a service) for sale at a conditionally determined price to a potential buyer. The potential buyer-102A-N may include a person and/or entity that may purchase items included in the offer. The acquisition module 104 may acquire (e.g., obtain a payment information from, identify as a potential buyer, contact via email, communicate with to enable an offer, etc.) an additional potential buyer. The aggregation module 106 may aggregate (e.g., associate with a price tier, incorporate in a conditionally determined price equation, compare with a number of confirmed purchases price determination table, etc.) a set of potential buyers (e.g., entity, person, etc.) to alter a conditionally determined price. The sale module 108 may enable selling the items at a price (e.g., that may be conditionally determined) to the set of potential buyers at a predetermined time.

In an example embodiment, FIG. 1 illustrates the buyer aggregation system. The offer module 100, the acquisition module 104, the aggregation module 106, and the sale module 108 may communicate with potential buyer-102A-N. The offer module 100, the acquisition module 104, the aggregation module 106, and the sale module 108 may all communicate with each other.

In one embodiment, an offer of two or more of an item (e.g., a good, a real property, an intangible property, and a service) may be generated for sale at a conditionally determined price to a potential buyer. The additional potential buyer may be acquired. A set of potential buyers may be aggregated (e.g., using the aggregation module 106) to affect the conditionally determined price. Two or more of the item may be sold (e.g., using the sale module 108) at the conditionally determined price to the set of potential buyers at a predetermined time. The conditionally determined price may be a predetermined set of two or more tiers (e.g., each tier may include a range of a quantity of the item purchased). Each tier may be associated with a price of the item. The price of the item of the tier may be less than the price of the item in an additional tier.

An upper threshold quantity of a purchased item of the tier may be greater than an additional upper threshold quantity of the additional tier (e.g., one tier may be associated with a greater number of committed purchasers than another tier). The set of potential buyers may be aggregated (e.g., using the aggregation module 106) to commit each buyer to purchase one item at the conditionally determined price. The conditionally determined price may be reduced by a preselected (e.g., chosen by a potential buyer and/or seller, determined by an algorithm, etc.) amount with each buyer added to the set of potential buyers and/or with each item that may be purchased by a potential buyer. The preselected amount may be the same for each reduction of the conditionally determined price. Alternatively, the preselected amount may be determined by a list, by the potential buyer and/or seller, by an algorithm, or through any other means of determining a price of an item.

The set of potential buyers may be aggregated to commit each buyer to purchase one item at the conditionally determined price. The conditionally determined price may be selected and/or associated with a threshold quantity of the purchased item. The sale of the item to the aggregated set of potential buyers may occur when the threshold quantity of the purchased item is exceeded. The aggregated set of potential buyers may not be committed to purchase the item until the threshold quantity of the purchased item is exceeded.

The offer may be communicated to the other potential buyer using an email, a fax, a text message, an instant message, a phone call, a voice message, an image, and/or a photo. A data may be stored including a transaction record and/or a potential buyer information. A supplemental potential buyer may be identified based on a purchase history and/or a potential buyer characteristic (e.g., an age, a gender, an employment category, a demographic, etc.) that may be associated with the potential buyer, the additional potential buyer, and/or the supplemental potential buyer.

The offer module 100 may generate an offer of two or more of an item for sale at a conditionally determined price to potential buyer. The acquisition module 104 may acquire (e.g., identify as a potential buyer, contact via email, communicate with to enable an offer, etc.) an additional potential buyer. The aggregation module 106 may aggregate (e.g., associate with a price tier, incorporate in a conditionally determined price equation, compare with a number of confirmed purchases price determination table, etc.) a set of potential buyers to affect the conditionally determined price. The sale module 108 may sell two or more of the item at the conditionally determined price to the set of potential buyers at a predetermined time.

The offer module 100 of a buyer aggregation system may be formed to generate an offer of two or more of an item (e.g., a good, a real property, an intangible property, a service, etc.) for sale at a conditionally determined price to a potential buyer. The acquisition module 104 may be created to acquire (e.g., identify as a potential buyer, contact via email, communicate with to enable an offer, etc.) an additional potential buyer. The aggregation module 106 may be created to aggregate (e.g., associate with a price tier, incorporate in a conditionally determined price equation, compare with a number of confirmed purchases price determination table, etc.) a set of potential buyers to affect the conditionally determined price (e.g., the set of potential buyers may include the potential buyer and/or the additional potential buyer).

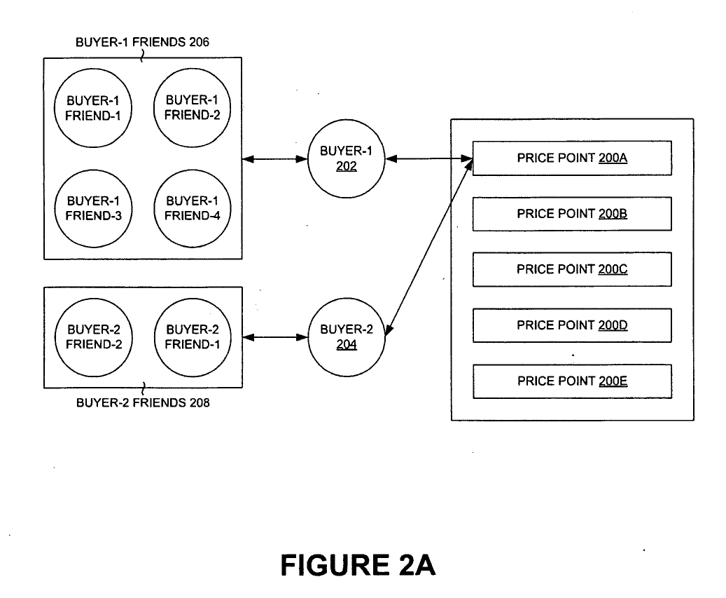

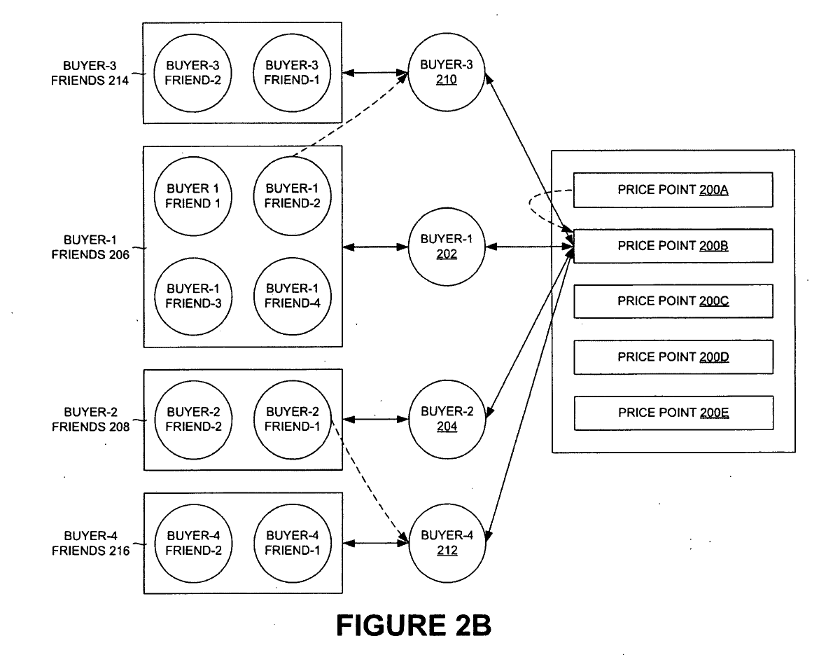

FIG. 2A and FIG. 2B are schematic views illustrating migration from one price tier to another price tier, according to one embodiment. In particular, FIG. 2 illustrates price points 200A-E, buyer-1 202, buyer-2 204, buyer-1 friends 206, buyer-2 friends 208, buyer-3 210, buyer-4 212, buyer-3 friends 214, and buyer-4 friends 216, according to one embodiment.

Price points 200A-E may be different prices associated with a minimum and maximum number of committed purchases of a particular product. When enough committed purchases have been aggregated, the price for all of the items in the offer may change from the price point 200A to price point 200B.

Buyer-1202 and buyer-2 204 may be entities/individuals who are interested in purchasing the product. Buyer-1 friends 206 may be associates of buyer-1 202 who are contacted by buyer-1 202 to see if they are also interested in purchasing the product. Buyer-2 friends 208 may be associates of buyer-2 204 who are contacted by buyer-2 204 to see if they are interested in also purchasing the product.

Buyer-3 210 may be an associate of buyer-1 202 who decides to commit to purchasing the product based on the contact made by buyer-1 202. When buyer-3 210 commits to purchasing the item, he may increase the number of committed purchases above a threshold amount to move the price for the item from price point 200A to price point 200B. Buyer-3 210 may be motivated to contact his own group of friends (e.g., buyer-3 friends 214) to encourage them to purchase the same item to further reduce price of the item.

Similarly, buyer-4 212 may be a friend of buyer-2 204 who decides to commit to purchasing the item, and who may also decide to encourage buyer-4 friends 216 to purchase the item. As the number of committed purchases increase, the price of the item may be reduced as additional threshold numbers of purchases are reached to qualify for other price tiers.

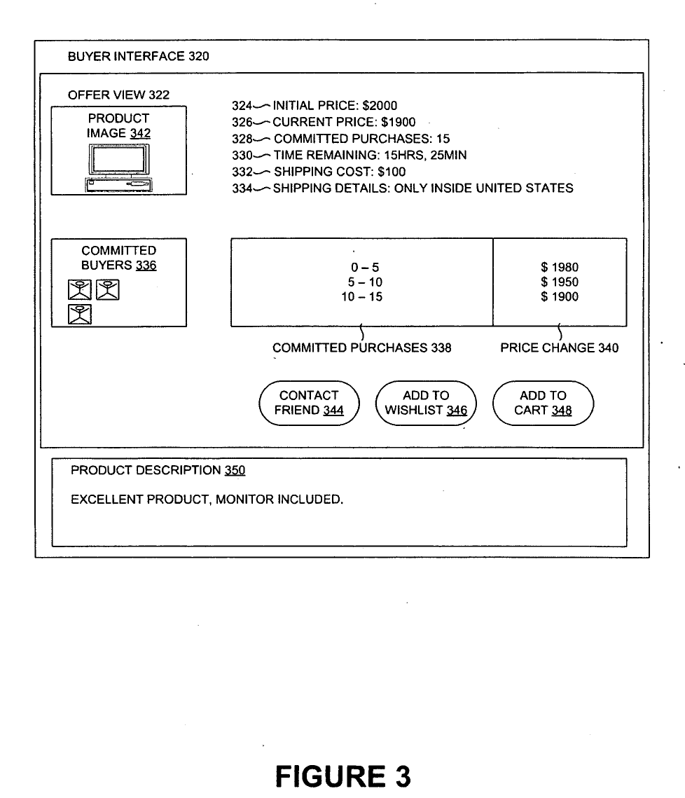

FIG. 3 is a user interface view illustrating buyer interface 320, according to one embodiment. In particular, FIG. 3 illustrates an offer view 322, an initial price 324, a current price 326, a committed purchases 328, a time remaining 330, a shipping cost 332, and shipping details 334. FIG. 3 further illustrates committed buyers 336, committed purchases 338, a price change 340, a product image 342, a contact friend 344, add to wishlist 346, add to cart 348, and a product description 350, according to one embodiment.

The offer view 322 may illustrate a product for sale to one or more potential buyers, terms for reducing the price by aggregating additional potential buyers, and/or details regarding when the product offer will conclude. The offer view 322 may present details regarding an initial offer price that may be reduced when enough potential buyers have been added to reach a subsequent price tier. Alternative offers may be presented in the offer view, such as a significantly reduced price if a target number of potential buyers has been reached. An additional alternative view may be a price for the item that is reduced in accordance with an algorithm for each additional item that is purchased and/or each additional purchaser that commits to purchasing the item. The algorithm may be a fixed reduction in price, an equation based on variables such as the current price and the number of potential buyers, and/or the algorithm may be based on a predetermined lookup table.

The initial price 324 may be an initial price for the product associated with a minimum number of purchasers and/or an initial price tier. The current price 326 may be a current offer price based on the number of committed purchases of the item and/or committed purchasers. Committed purchases 328 may illustrate the number of purchases of the item that have been committed to since the conditional offer of the product began. The time remaining 330 may illustrate a time limit for the buyer to purchase the product. The shipping cost 332 may illustrate the additional cost other than product cost required for transportation and delivery of the product to the buyer. Shipping details 334 may illustrate the information associated with shipping locations (e.g., inside the US, European nations only, etc.) and cost (e.g., extra shipping cost outside the US, etc.). Committed buyers 336 may illustrate the number of buyers who have committed to buying the product at the price ultimately reached as determined by the terms of the conditional offer and the number of committed purchasers and/or committed purchases of the item at the conclusion of the conditional offer time limit.

Committed purchases 338 may illustrate the number of committed purchases made by the users. The price change 340 may illustrate changes in the offer price for all committed buyers that may have been affected by the number of committed purchases. The product image 342 may be an image of the product that is being offered for sale. The contact friend 344 may be an option that enables the buyer to contact a friend who is interested in buying the kind of products, whether through the buyer's contact list, a list of friends input by the buyer, and/or through a pregenerated form email to an email address input by the buyer. Add to wishlist 346 may be an option that enables the buyer to add the item to a wish list so that he can be reminded of buying it later and/or to enable other buyers to buy it for him (e.g., as a gift, etc.). Add to cart 348 may be an option that enables the buyer to aggregate the product with other products for so that all the product items can be bought at once. Add to cart 348 may commit the buyer to purchasing the item in accordance with the terms of the current conditional offer being viewed by the buyer. Product description 350 may be space in the buyer's interface 320 that gives a description of the product being sold.

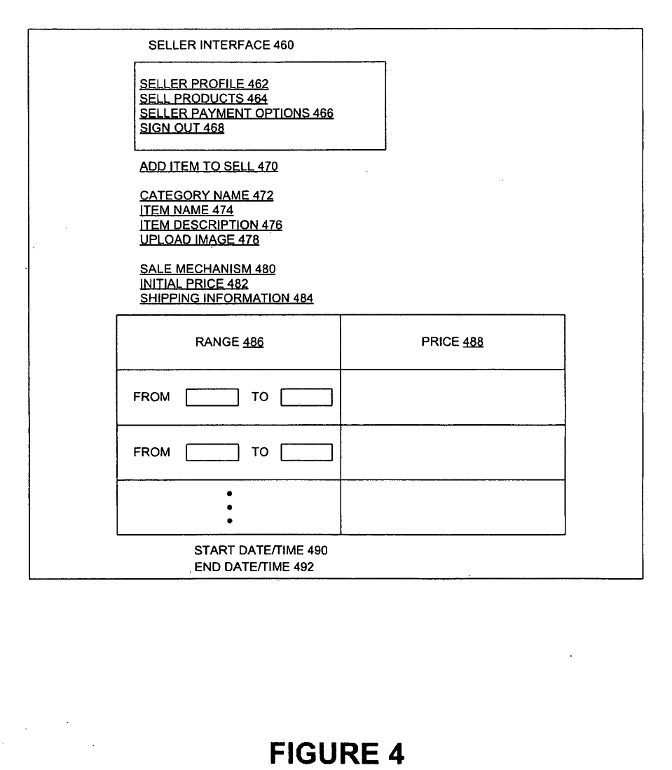

FIG. 4 is a user interface view illustrating seller interface 460, according to one embodiment. In particular, FIG. 4 illustrates seller interface 460, seller profile 462, sell products 464, seller payment options 466, sign out 468, add item to sell 470, category name 472, item name 474, item description 476, upload image 478, sale mechanism 480, initial price 482, shipping information 484, range 486, price 488, start date/time 490, and end date/time 492, according to one embodiment.

Seller profile 462 may be a link that enables the seller to navigate to a profile page of the seller. Sell products 464 may be a link that enables the seller to navigate to a page that enables the seller to sell his product online. Seller payment options 466 may be an option that enables the seller to navigate to a secure page that has transaction options such as linked bank accounts for accepting payment, PayPal® accounts, etc. Sign out 468 may be an option that enables the seller to sign out of the page. Add item to sell 470 may enable the seller to add more items to sell online. Category name 472 may enable the seller to choose a category of his product. The item name 474 may enable the seller to provide a name of the item that is intended to be for sale. The item description 476 may enable the seller to provide a description of his product.

Upload image 478 may enable the seller to upload an image of the item that is intended to be for sale. Sale mechanism 480 may allow the seller to determine what algorithm or pricing mechanism to use to allow potential buyers to affect the purchase price of the item (e.g., price tiers, an algorithmically determined conditional price based on committed purchases, a target number of buyers, etc.). The initial price 482 may enable the seller to provide an initial price for the product that is intended to be sold. Shipping information 484 may enable the seller to provide information to potential buyers about the product shipping information. Range 486 may represent a minimum and maximum number of committed purchasers for a set of one or more price tiers in a conditional offer. The price 488 may be the price of the product associated with a particular tier of a conditional offer, which may be associated with a minimum and maximum number of committed purchasers in the tier (e.g., the range of buyers in the tier). The maximum number of purchasers may be limited by the quantity of a product that the seller may be able to offer for sale, whether through future acquisitions of the product or based on the number currently in stock. The start date/time 490 may be an option that enables the seller to set a date to begin offering the product. The end date/time 492 may be an option that enables the seller to set an end time for offering the product in a limited time period conditional offer.

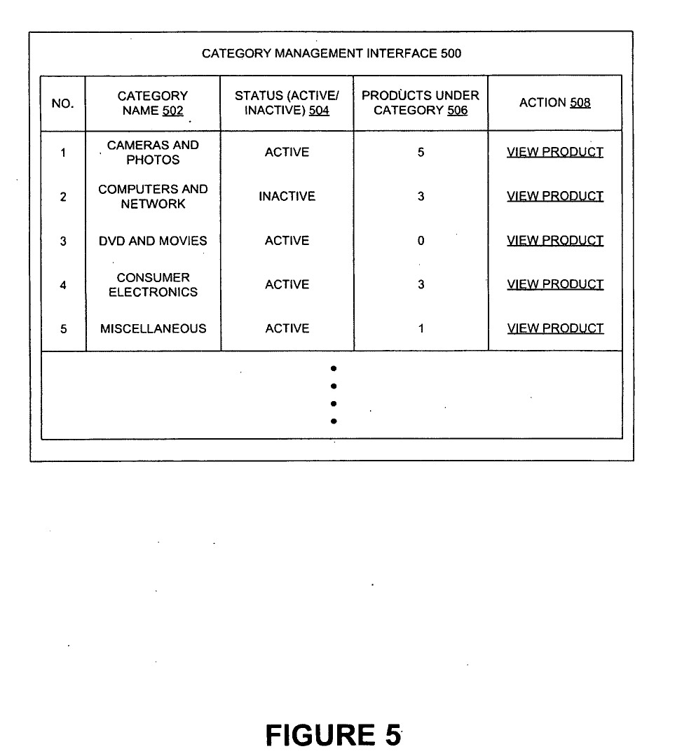

FIG. 5 is a category management interface 500 view, according to one embodiment. In particular, FIG. 5 illustrates category management interface 500, category name 502, status (active/inactive) 504, products under category 506, and action 508. The category management interface 500 may provide a site administrator, a seller, and/or a potential buyer with information relating to the categories of products that are being and/or have been offered for sale through the online site. Category name 502 may illustrate the categories of products (e.g., cameras and photos, computers and network, consumer electronics, etc.) that can be and/or are being offered for sale. The status 504 may illustrate whether the category and products associated to the category are being offered for purchase. Products under category 506 may illustrate the number of products being offered that fall within the particular category (e.g., 5 products offered for sale under cameras and photos). Action 508 may enable the user of the interface to view the category and associated products and to make changes within the buyer affected aggregation of purchasers system.

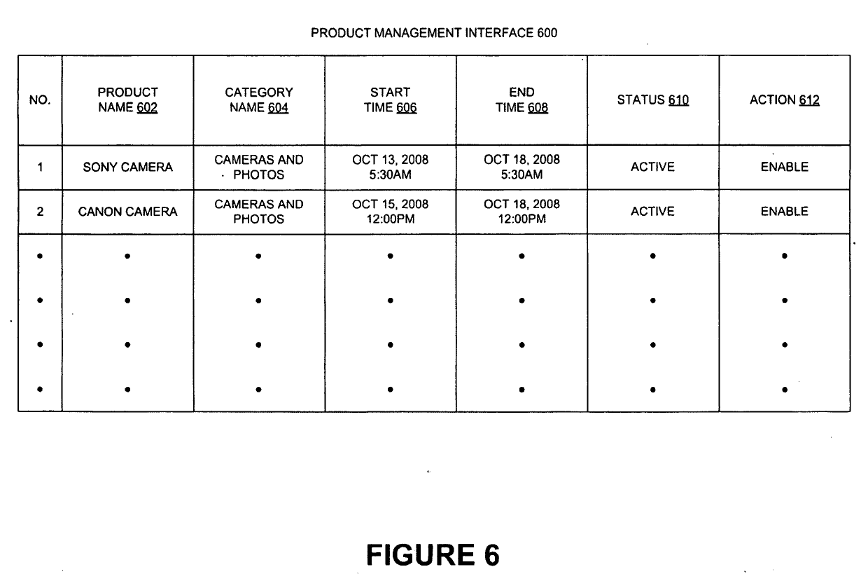

FIG. 6 is a product management interface 600 view, according to one embodiment. In particular, FIG. 6 illustrates product name 602, category name 604, start time 606, end time 608, status 610, and action 612, according to one embodiment. Product name 602 may illustrate the products being offered for sale (e.g., Sony® camera, Canon® camera, etc.). Category name 604 may illustrate which category a product illustrated in the product name 602 may belong under (e.g., cameras may come under the category cameras and photos, etc.). Start time 606 may illustrate the start time (e.g., Oct. 13, 2008, 5:30 AM, etc.) of a conditional offer. The end time 608 may illustrate the time (e.g., Oct. 18, 2008, 5:30 AM) when the conditional offer is concluded and a price of all of the items is determined in accordance with the terms of the conditional offer. The status 610 may illustrate whether a conditional offer is still pending, and/or if a sale has been concluded. The action 612 may provide an option for the user (e.g., administrator) of the interface to enable the product of the seller in the website.

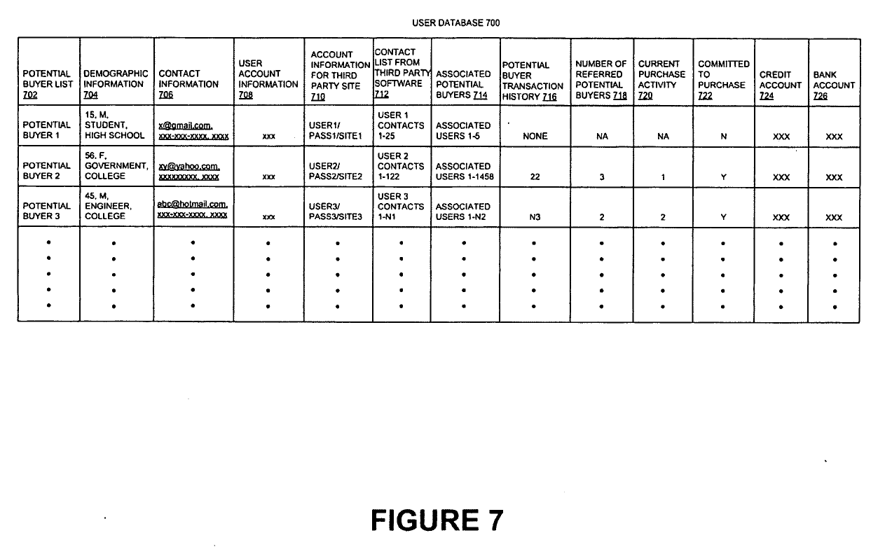

FIG. 7 is a table view illustrating a user database 700, according to one embodiment. In particular, FIG. 7 illustrates user database 700, potential buyer list 702, demographic information 704, contact information 706, user account information 708, account information for third party site 710, contact list from third party software 712, associated potential buyers 714, potential buyer transaction history 716, number of referred potential buyers 718, current purchase activity 720, committed to purchase 722, credit account 724, credit account 724, and bank account 726, according to one embodiment.

Potential buyer list 702 illustrates potential buyers (e.g., potential buyer-1, potential buyer-2, etc.) of items in the online website. Demographic information 704 may illustrate the identifying characteristics (e.g., age, gender, occupation, etc.) of the associated potential buyer. Contact information 706 may illustrate contact information (e.g., telephone number, email address, fax, etc.) associated with the potential buyer. User account information 708 may illustrate information (e.g., permanent, temporary, etc.) associated to the user account. Account information for third party site 710 may illustrate information pertaining to third party accounts for the user that may allow the buyer aggregation system to identify friends of the buyer and/or additional potential buyers of items. Contact list from third party software 712 may include contacts (e.g., additional potential buyers) obtained from a third party software (e.g., a social networking site, an Outlook® email address book, etc.). Associated potential buyers 714 may illustrate potential buyers who are associated (e.g., friends, references, etc.) to the particular potential buyer illustrated in potential buyer list 702. Potential buyer transaction history 716 may illustrate transactions done in the past (e.g., number of transactions, etc.).

Number of referred potential buyers 718 may illustrate a number of potential buyers referred by the potential buyers (e.g., through friends, etc.). Current purchase activity 720 may illustrate the present active number of transactions by the potential buyer. Committed to purchase 722 may illustrate whether the potential buyer is committed to purchase a product that is active on the trading website. Credit account 724 may illustrate information associated to the potential buyer credit account. Bank account 726 may illustrate bank account information associated to the potential buyer.

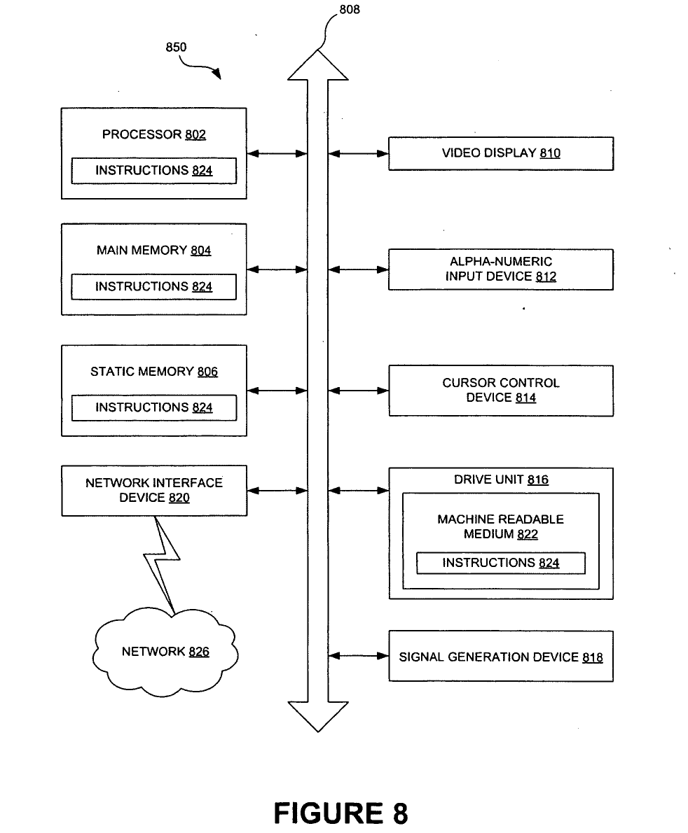

FIG. 8 is a diagrammatic system view of a data processing system in which any of the embodiments disclosed herein may be performed, according to one embodiment. Particularly, the diagrammatic system view 850 of FIG. 8 illustrates a processor 802, a main memory 804, a static memory 806, a bus 808, a video display 810, an alpha-numeric input device 812, a cursor control device 814, a drive unit 816, a signal generation device 818, a network interface device 820, a machine readable medium 822, instructions 824, and a network 826, according to one embodiment.

The diagrammatic system view 850 may indicate a personal computer and/or the data processing system in which one or more operations disclosed herein are performed. The processor 802 may be a microprocessor, a state machine, an application specific integrated circuit, a field programmable gate array, etc. (e.g., Intel® Pentium® processor). The main memory 804 may be a dynamic random access memory and/or a primary memory of a computer system.

The static memory 806 may be a hard drive, a flash drive, and/or other memory information associated with the data processing system. The bus 808 may be an interconnection between various circuits and/or structures of the data processing system. The video display 810 may provide graphical representation of information on the data processing system. The alpha-numeric input device 812 may be a keypad, a keyboard and/or any other input device of text (e.g., a special device to aid the physically handicapped).

The cursor control device 814 may be a pointing device such as a mouse. The drive unit 816 may be the hard drive, a storage system, and/or other longer term storage subsystem. The signal generation device 818 may be a bios and/or a functional operating system of the data processing system. The network interface device 820 may be a device that performs interface functions such as code conversion, protocol conversion and/or buffering required for communication to and from the network 826. The machine readable medium 822 may provide instructions on which any of the methods disclosed herein may be performed. The instructions 824 may provide source code and/or data code to the processor 802 to enable any one or more operations disclosed herein.

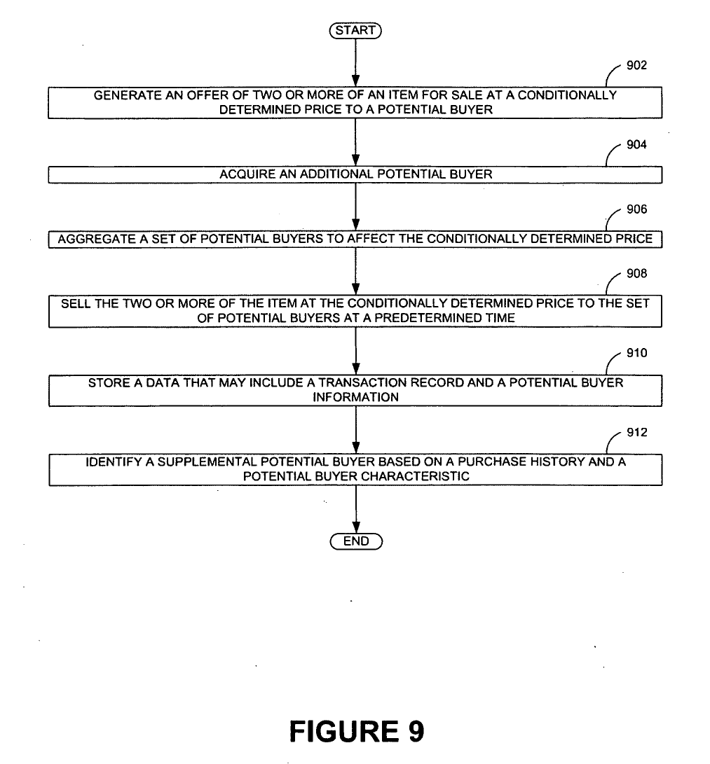

FIG. 9 is a process flow illustrating aggregating a set of potential buyers to affect a conditionally determined price, according to one embodiment. In operation 902, an offer for two or more items (e.g., the item may be a good, a real property, an intangible property and/or a service) may be generated (e.g., using the offer module 100 of FIG. 1) for sale at a conditionally determined price to a potential buyer (e.g., the potential buyer-102A-N of FIG. 1).

In operation 904, an additional potential buyer may be acquired (e.g., using the acquisition module 104 of FIG. 1). In operation 906, a set of potential buyers may be aggregated (e.g., using the aggregation module 106 of FIG. 1) to affect the conditionally determined price. A processor and a nonvolatile memory may be used to aggregate the set of potential buyers. In operation 908, two or more of the items may be sold (e.g., using the sale module 108 of FIG. 1) at the conditionally determined price to the set of potential buyers at a predetermined time. The conditionally determined price may be a predetermined set of two or more tiers. Each tier may be comprised of a range of a quantity of the item purchased and/or each tier may be associated with a price of the item.

The price of the item of the tier may be less than the price of the item in an additional tier. An upper threshold quantity of a purchased item of the tier may be greater than an additional upper threshold quantity of the additional tier. Aggregating (e.g., associating with a price tier, incorporating in a conditionally determined price equation, comparing with a number of confirmed purchases price determination table, etc.) the set of potential buyers (e.g., the potential buyer-102A-N of FIG. 1) may commit each buyer to purchase two or more items at the conditionally determined price. The conditionally determined price may be reduced by a preselected amount with each buyer added to the set of potential buyers (e.g., the potential buyer-102A-N of FIG. 1).

The preselected amount may be the same for each reduction of the conditionally determined price. Aggregating a set of potential buyers (e.g., the potential buyer-102A-N of FIG. 1) may commit each buyer to purchase two or more items at the conditionally determined price. The conditionally determined price may be selected and associated with a threshold quantity of the purchased item. The sale of the item to the aggregated set of potential buyers may occur when the threshold quantity of the purchased item is exceeded.

The aggregated set of potential buyers may not be committed to purchase the item until the threshold quantity of the purchased item is exceeded. The offer may be communicated to the other potential buyer using one or more of an email, a fax, a text message, an instant message, a phone call, a voice message, an image, and/or a photo. In operation 910, a data including a transaction record and/or a potential buyer information may be stored. In operation 912, a supplemental potential buyer (e.g., a previously uninvolved third party, a person known to the potential buyer, etc.) may be identified based on a purchase history and/or a potential buyer characteristic (e.g., an age, a gender, an employment category, a demographic, etc.) that may be associated with the potential buyer, the additional potential buyer, and/or the supplemental potential buyer.

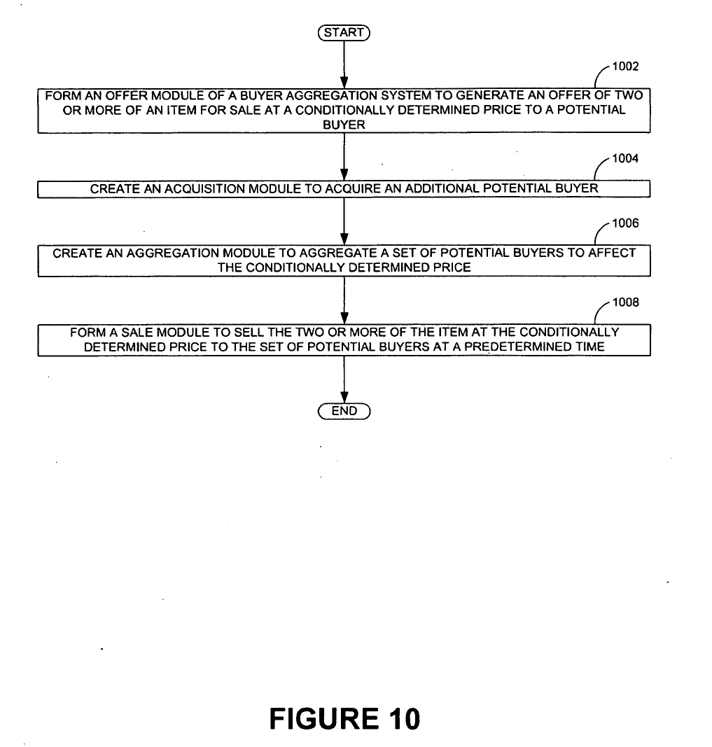

FIG. 10 is a process flow illustrating generation of modules in a buyer aggregation system for selling items, according to one embodiment. In operation 1002, an offer module (e.g., the offer module 100 of FIG. 1) of a buyer aggregation system may be formed to generate an offer of two or more items (e.g., a good, a real property, an intangible property, and/or a service) for sale at a conditionally determined price to a potential buyer (e.g., the potential buyer-102A-N of FIG. 1).

In operation 1004 an acquisition module (e.g., the acquisition module 104 of FIG. 1) may be created to acquire (e.g., identify as a potential buyer, contact via email, communicate with to enable an offer, etc.) an additional potential buyer. In operation 1006, an aggregation module (e.g., the aggregation module 106 of FIG. 1) may be created to aggregate a set of potential buyers (e.g., the potential buyer-102A-N of FIG. 1) to aggregate a set of potential buyers to affect the conditionally determined price. The set of potential buyers may include the potential buyer and/or the additional potential buyer. A processor and a nonvolatile memory may be used to aggregate the set of potential buyers.

In operation 1008, a sale module (e.g., the sale module 108 of FIG. 1) may be formed to sell two or more of the items at the conditionally determined price to the set of potential buyers at a predetermined time.

In an example embodiment, a seller may wish to allow one or more potential buyers to identify additional potential buyers. The seller may desire to increase the number of items (e.g., products and/or services) that the seller may provide to one or more buyers. Increasing the number of items sold may allow the seller to increase revenue and/or profit. The seller may wish to decrease an offer price when a greater quantity of items are sold, which may encourage a potential buyer to contact additional potential buyers to purchase items at the same time.

In another embodiment, a potential buyer may wish to purchase an item (e.g., a good and/or a service) from a seller for less money. The potential buyer may know of additional contacts who may be interested in the same item. The potential buyer may be willing to contact other potential buyers, who may be known to the potential buyer and/or suggested by the seller and/or other interested parties. The system may allow other interested companies and/or individuals to provide contact information for potential buyers of an item (e.g., a good and/or a service). In an embodiment, additional potential buyers may be identified by their prior purchase histories, their social networks, and/or demographic information such as age, gender, and employment.

In the embodiment, as additional potential buyers are encouraged to join in the sale and/or purchase of items, the price for each item is decreased in accordance with the established terms of the offer. The embodiment allows the price to be decreased in tiers as threshold numbers of committed buyers are reached. For example, a first tier may include 1 to 10 committed items purchased, and a second tier with a lower price may include 11-20 committed items purchased. In another embodiment, the group of potential buyers may not be committed to purchase the items until a target number of purchases has been reached, which will allow the item to be purchased at a lower price. In another embodiment, the potential buyers may be able to decrease the price of the item with each additional committed potential buyer and/or item to be purchased. The reduction of the price may be the same for each additional committed purchase of an item (e.g., a good and/or service).

In an embodiment, at the end of the sale process, a group of potential buyers may have successfully reduced the purchase price of the item by aggregating a group of potential buyers to purchase a type of item. These potential buyers may be able to affect the price through convincing other buyers to also purchase an item. The seller may have been able to sell a larger quantity of a particular item to a group of potential buyers that may otherwise have used another vendor to make their purchase, thus increasing the revenue and profit for the seller. The seller may also have been able to increase the rate at which a particular item is sold.

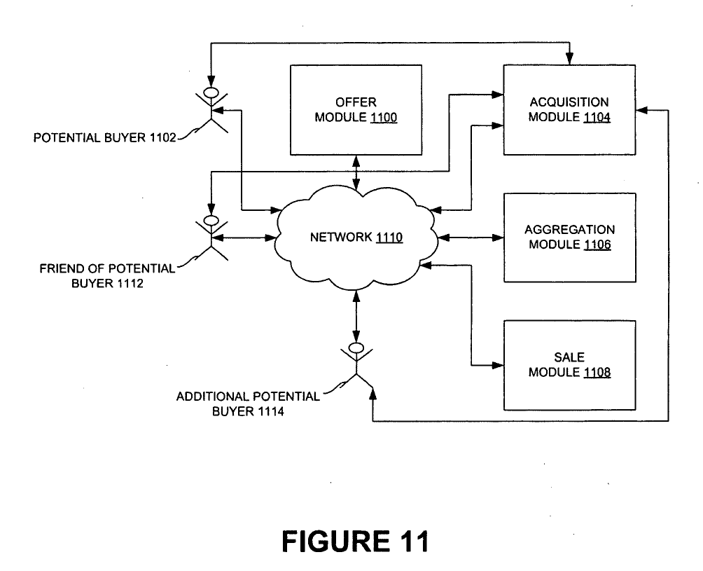

FIG. 11 is a system view illustrating a potential buyer communicating with a network and modules of the buyer aggregation system, according to one embodiment. Particularly, FIG. 11 illustrates an offer module 1100, a potential buyer-1 102, an acquisition module 1104, an aggregation module 1106, a sale module 1108, a network 1110, and a friend of potential buyer-1112, according to one embodiment.

The offer module 1100, the potential buyer-1102, the acquisition module 1104, the aggregation module 1106 and the sale module 1108 illustrated in FIG. 11 may be the same as the modules in FIG. 1. The network 1110 (e.g., LAN, WAN, mobile, telecommunications, internet, intranet, WiFi and/or ZigBee network, etc.) may enable communication between the potential buyers and the buyer affected aggregation of purchasers system (e.g., an online trading website). The friend of potential buyer-1112 may be a patron (e.g., a potential buyer referred by potential buyer-1 102) who has an interest in buying the same good from the online trading website that the potential buyer-1102 is purchasing. In another embodiment, the friend of the potential buyer may be interested in a product distinct from the product that the potential buyer-1102 is considering.

In an example embodiment, the potential buyers may communicate with the online trading website through the network 1110. The offer module 1100, the acquisition module 1104, the aggregation module 1106, and the sale module 1108 may communicate with each other through the network 1110. The potential buyers may communicate with the acquisition module 1104 which may identify, communicate with, and/or assist with forms of communication between potential buyers, such as through email, coupons, and/or voicemails.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software embodied in a machine readable medium of a physical memory. For example, the various electrical structures and methods may be embodied using transistors, logic gates, and electrical circuits (e.g., application specific integrated (ASIC) circuitry and/or in Digital Signal Processor (DSP) circuitry).

Particularly the offer module 100, the acquisition module 104, the aggregation module 106, the sale module 108, the potential buyer-102A-N of FIG. 1-11 may be enabled using software and/or using transistors, logic gates, and electrical circuits (e.g., application specific integrated ASIC circuitry) such as an offer circuit, an aggregation circuit, a communication circuit, a sale circuit, and other circuit.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A buyer altered aggregation of purchasers method, comprising:
generating an offer of at least two of an item for sale at a conditionally determined price to a potential buyer;
acquiring an additional potential buyer;
aggregating a set of potential buyers to affect the conditionally determined price, wherein a processor and a nonvolatile memory are used to aggregate the set of potential buyers; and
selling the at least two of the item at the conditionally determined price to the set of potential buyers at a predetermined time.

2. The method of claim 1, wherein the item is at least one of a good, a real property, an intangible property, and a service.

3. The method of claim 2, wherein the conditionally determined price is a predetermined set of at least two tiers, wherein each tier is comprised of a range of a quantity of the item purchased, and wherein each tier is associated with a price of the item.

4. The method of claim 3, wherein the price of the item of the tier is less than the price of the item in an additional tier, wherein an upper threshold quantity of a purchased item of the tier is greater than an additional upper threshold quantity of the additional tier.

5. The method of claim 4, wherein aggregating the set of potential buyers commits each buyer to purchase at least one item at the conditionally determined price.

6. The method of claim 2, wherein the conditionally determined price is reduced by a preselected amount with each buyer added to the set of potential buyers.

7. The method of claim 6, wherein the preselected amount is the same for each reduction of the conditionally determined price.

8. The method of claim 7, wherein aggregating a set of potential buyers commits each buyer to purchase at least one item at the conditionally determined price.

9. The method of claim 2, wherein the conditionally determined price is selected and associated with a threshold quantity of the purchased item, and wherein the sale of the item to the aggregated set of potential buyers occurs when the threshold quantity of the purchased item is exceeded.

10. The method of claim 9 wherein the aggregated set of potential buyers is not committed to purchase the item until the threshold quantity of the purchased item is exceeded.

11. The method of claim 2, wherein the offer is communicated to the other potential buyer using at least one of an email, a fax, a text message, an instant message, a phone call, a voice message, an image, and a photo.

12. The method of claim 2, further comprising storing a data comprised of at least one of a transaction record and a potential buyer information.

13. The method of claim 12, further comprising identifying a supplemental potential buyer based on at least one of a purchase history and a potential buyer characteristic, and wherein a machine is caused to perform the identification by a processor executing a set of instructions stored in a machine readable medium of a physical memory.

14. A buyer altered aggregation of purchasers system, comprising:
an offer module to generate an offer of at least two of an item for sale at a conditionally determined price to a potential buyer;
an acquisition module to acquire an additional potential buyer;
an aggregation module to aggregate a set of potential buyers to affect the conditionally determined price, wherein the set of potential buyers is comprised of the potential buyer and the additional potential buyer, wherein a processor and a nonvolatile memory are used to aggregate the set of potential buyers; and
a sale module to sell the at least two of the item at the conditionally determined price to the set of potential buyers at a predetermined time.

15. The system of claim 14, wherein the item is at least one of a good, a real property, an intangible property, and a service.

16. The system of claim 15, wherein the conditionally determined price is a predetermined set of at least two tiers, wherein each tier is comprised of a range of a quantity of the item purchased, and wherein each tier is associated with a price of the item.

17. The system of claim 16, wherein the price of the item of the tier is less than the price of the item in an additional tier, wherein an upper threshold quantity of a purchased item of the tier is greater than an additional upper threshold quantity of the additional tier.

18. The system of claim 17, wherein aggregating a set of potential buyers commits each buyer to purchase at least one item at the conditionally determined price.

19. The method, comprising:
forming an offer module of a buyer aggregation system to generate an offer of at least two of an item for sale at a conditionally determined price to a potential buyer;
creating an acquisition module to acquire an additional potential buyer;
creating an aggregation module to aggregate a set of potential buyers to affect the conditionally determined price, wherein the set of potential buyers is comprised of the potential buyer and the additional potential buyer, wherein a processor and a nonvolatile memory are used to aggregate the set of potential buyers;
forming a sale module to sell the at least two of the item at the conditionally determined price to the set of potential buyers at a predetermined time.

20. The method of claim 19, wherein the item is at least one of a good, a real property, an intangible property, and a service.
